(19) United States
(12) Patent Application Publication
(10) Pub. No.: US 2018/0191662 A1
(43) Pub. Date: Jul. 5, 2018

(54) SYSTEMS AND METHODS FOR DELIVERING LOW LATENCY REAL-TIME UPDATES

(71) Applicant: Facebook, Inc., Menlo Park, CA (US)

(72) Inventors: Peter Wang Weng, Bellevue, WA (US); John Richard Sherwood, Seattle, WA (US); Daniel L. Schafer, San Francisco, CA (US); Laney Elizabeth Kuenzel, Cambridge, MA (US)

(21) Appl. No.: 15/394,797

(22) Filed: Dec. 29, 2016

(51) Int. Cl. H04L 12/58; H04L 29/08

(52) U.S. Cl. CPC H04L 51/24; H04L 51/32; H04L 67/22; H04L 67/18; H04L 51/04

(57) ABSTRACT

Systems, methods, and non-transitory computer-readable media can generate subscription information associated with a user and a content item, wherein the subscription information is indicative of the user viewing the content item. The subscription information is stored at a first data center. A determination is made to replicate the subscription information based on replication criteria. The subscription information is replicated to one or more additional data centers based on the making the determination to replicate the subscription information.

### FIELD OF THE INVENTION

The present technology relates to the field of social networking systems. More particularly, the present technology relates to systems and methods for delivering low latency real-time updates.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a graphical user interface to view and interact with the social networking system. For example, the graphical user interface can be presented via a mobile application on a user's mobile device, or via a web browser on a user's computing device. The graphical user interface can provide users with the ability to post, view, and otherwise interact with content items on the social networking system.

### SUMMARY

Various embodiments of the present disclosure can include systems, methods, and non-transitory computer readable media configured to generate subscription information associated with a user and a content item, wherein the subscription information is indicative of the user viewing the content item. The subscription information is stored at a first data center. A determination is made to replicate the subscription information based on replication criteria. The subscription information is replicated to one or more additional data centers based on the making the determination to replicate the subscription information.

In an embodiment, the replication criteria comprise potential audience criteria.

In an embodiment, the replication criteria comprise current audience criteria.

In an embodiment, the replication criteria comprise network usage criteria.

In an embodiment, the network usage criteria comprise a low usage period identified based on historical network usage data.

In an embodiment, the making the determination to replicate the subscription information comprises making a determination to replicate all subscription information associated with the content item.

In an embodiment, the replicating the subscription information to one or more additional data centers comprises replicating the subscription information to all data centers of a social networking system.

In an embodiment, the making the determination to replicate the subscription information comprises determining a subset of data centers of a plurality of available data centers to which the subscription information will be replicated.

In an embodiment, the first data center is associated with a geographic region in which the user is located.

In an embodiment, it is determined that the user is no longer viewing the content item. The subscription information is removed from the first data center and the one or more additional data centers.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a real-time updates module, according to an embodiment of the present disclosure.

FIG. 2 illustrates an example scenario including a functional block diagram associated with providing real-time updates without replication of subscription information, according to an embodiment of the present disclosure.

FIG. 3 illustrates an example scenario including a functional block diagram associated with providing real-time updates with replication of subscription information, according to an embodiment of the present disclosure.

FIG. 4 illustrates an example method associated with replicating subscription information based on a replication determination, according to an embodiment of the present disclosure.

FIG. 5 illustrates an example method associated with providing real-time updates for a content item, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Systems and Methods for Delivering Low Latency Real-Time Updates

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a graphical user interface to view and interact with the social networking system. For example, the graphical user interface can be presented via a mobile application on a user's mobile device, or via a web browser on a user's computing device. The graphical user interface can provide users with the ability to post, view, and otherwise interact with content items on the social networking system. As users interact with a content item, e.g., by liking or commenting on the content item, other users on the social networking system may be able to view those interactions. Viewing other users' interactions with a content item may encourage interaction by additional users.

It continues to be an important interest for a social networking system to encourage users to interact with content items on the social networking system. Continued user interaction with content on the social networking is an important aspect of maintaining and growing interest in and participation on the social networking system. It has been demonstrated that providing users with real-time updates of user interactions can be beneficial in promoting additional interaction. For example, if a user is viewing a content item, and is provided with a real-time indication of other users liking the content item (e.g., being presented with a number of likes increasing in real-time), the user may be more inclined to like or comment on the content item. Or if the user is presented with a real-time indication of other users commenting on the content item (e.g., real-time posting of other users' comments, or a type indicator indicating that another user is currently typing a comment), the user may be more likely to like or comment on the content item. However, given that a social networking system may have millions of users looking at millions of different content items at any given moment, provision of reliable, real-time content item updates can be very taxing on a social networking system's network resources, and can also result in very inefficient use of resources.

An improved approach rooted in computer technology overcomes the foregoing and other disadvantages associated with conventional approaches specifically arising in the realm of computer technology. In general, when a user opens and/or views a content item on a social networking system, a subscription can be generated between the user and the content item. In other words, the subscription indicates that the user viewing the content item is “subscribed” to the content item so that the user can receive real-time updates for that content item. When a user closes the content item (e.g., stops viewing the content item), the subscription can be closed or deleted. Subscription information associated with the subscription can be stored in a data center. In various embodiments, a social networking system may comprise a plurality of data centers. In certain embodiments, each data center may be associated with a geographic region. Subscription information associated with a user's subscription may be stored in a data center associated with the geographic region in which the user is located. In order to provide users with low latency, real-time updates, subscription information can be replicated to additional data centers (e.g., all data centers). However, such replication can be very costly and inefficient. As such, in various embodiments, a replication determination may be made as to whether or not to replicate subscription information for certain subscriptions based on replication criteria. Replication criteria can be implemented so that subscription information is replicated when it is likely to be useful, i.e., it is likely that one or more users will interact with a content item while one or more other users are viewing, or subscribed to, the content item, and is not replicated when it is likely to go unused. For example, replication criteria can include a subscriber threshold, such that subscription information is only replicated for a content item if the content item has a threshold number of current subscribers (i.e., a threshold number of users currently viewing the content item). In another example, the replication criteria can include potential audience criteria. For example, if a content item has privacy restrictions imposed such that only a small number of users can view the content item, subscriptions to that content item may not be replicated. If the replication determination results in a determination that subscription information should be replicated, the subscription information can be replicated to one or more additional data centers. These concepts will be described in greater detail herein.

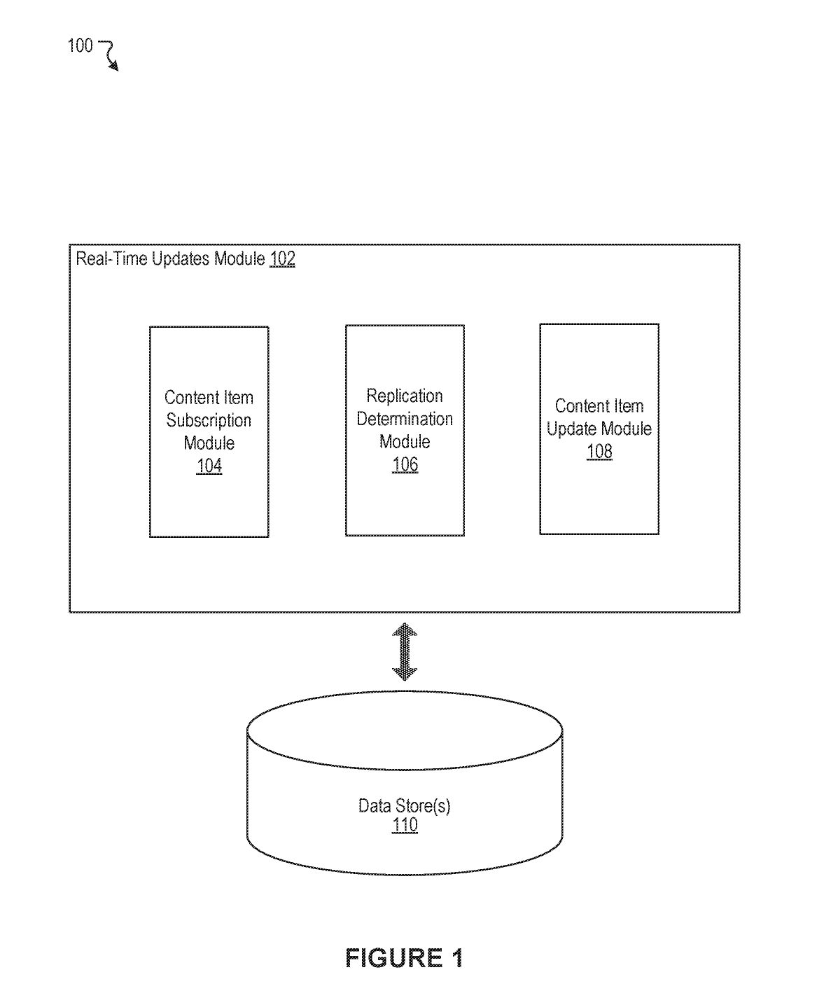

FIG. 1 illustrates an example system 100 including a real-time updates module 102, according to an embodiment of the present disclosure. The real-time updates module 102 can be configured to provide low latency, real-time updates for content items. In certain embodiments, when a user opens and/or views a content item, a subscription may be generated for the user and the content item. The subscription allows the user to acquire real-time (or near real time) updates for the content item while the user is viewing the content item. When the user closes the content item, or stops viewing the content item, the subscription is deleted. Real-time updates can include, for example, a running tally of the number of users that have liked the content item, a running tally of the number of users that have commented on the content item, a real-time indication that another user is currently typing a comment for the content item, a real-time stream of other users' comments on the content item as they are being posted, etc. In order to provide real-time updates having the lowest latency possible, subscription information can be replicated to multiple data centers. Provision of real-time updates is discussed in more detail herein.

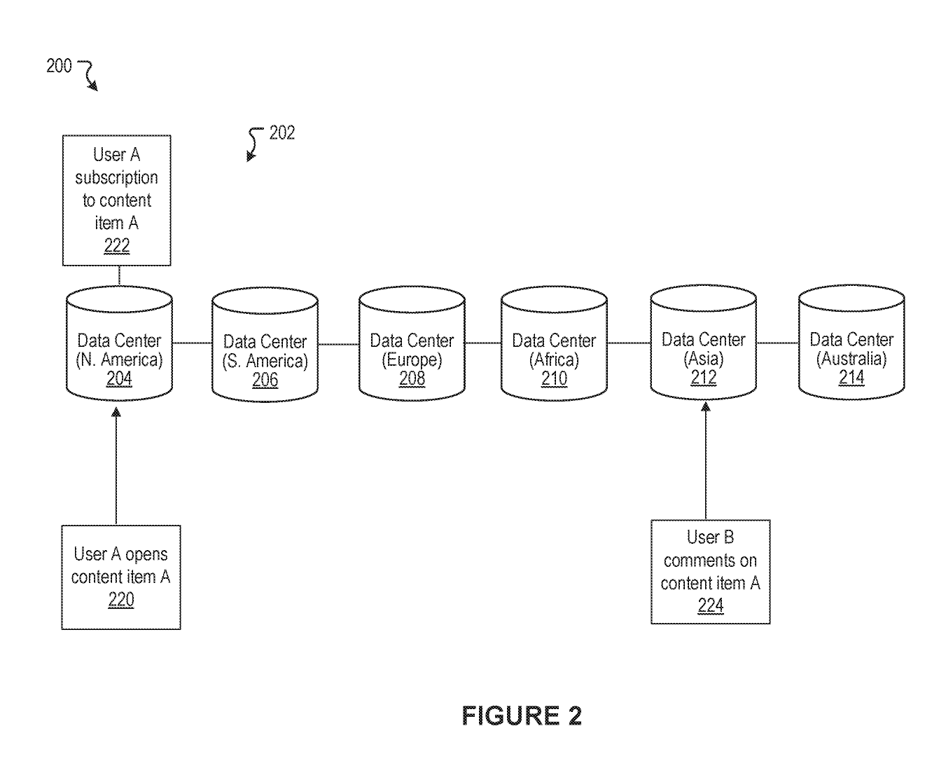

FIG. 2 illustrates an example scenario 200 including a functional block diagram 202 associated with providing real-time updates without replicating subscription information. As discussed above, a social networking system may comprise a plurality of data centers in different geographic regions. In FIG. 2, six data centers 204, 206, 208, 210, 212, 214 are illustrated. Each data center can be associated with one or more geographic regions (i.e., North America, South America, Europe, Africa, Asia, and Australia). While some example geographic regions are shown, the present disclosure can be applied to geographic regions at any level or category (e.g., continent, subcontinent, nation, state, etc.). When a user opens and/or views a content item, a subscription is generated for the user and the content item. Subscription information may be generated and stored for the user and the content item in a data center. The data center may be the data center associated with the geographic region in which the user is located. In the example scenario 200, User A has opened content item A (block 220). User A is located in North America. As a result, a subscription is generated indicating that User A is viewing content item A, and subscription information 222 is stored in the North America data center 204. The subscription information 222 will remain stored in the data center 204 until User A stops viewing content item A, at which point the subscription will be closed and subscription information 222 will be deleted.

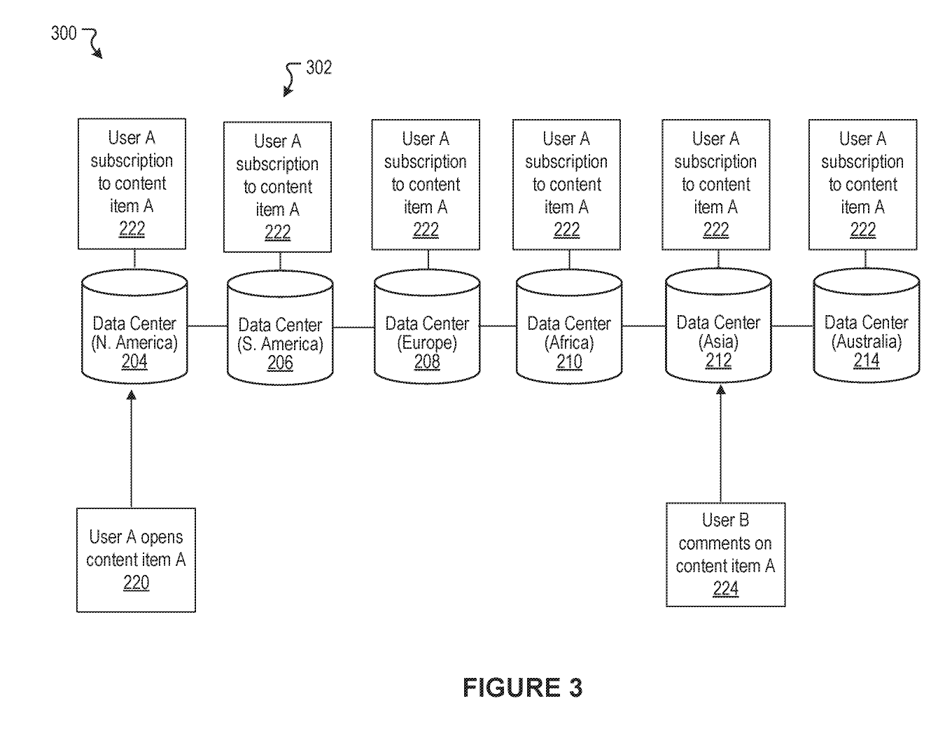

When a second user interacts with the content item, a content item update indicative of the interaction may be reported to a data center associated with the geographic region in which the second user is located. In the example scenario 200, User B has commented on content item A (block 224). User B is located in Asia. As such, a content item update (i.e., User B's comment on content item A) is reported to the Asia data center 212. Real-time updates can be provided to all users currently viewing content item A to indicate that User B has commented on content item A. In order to provide real-time updates to all users viewing content item A, a social networking system can query each data center to see which users are currently subscribed to content item A. For example, in the example scenario 200, once the Asia data center 212 receives notification of the content item update for content item A (block 224), each of the six data centers can be queried to identify all users that are currently subscribed to content item A. When the North America data center 202 is queried, subscription information 222 will indicate that User A is subscribed to content item A. A content item update can then be provided to User A so that User A can see that User B has commented on content item A. However, the time it takes to query each data center increases the latency with which real-time updates can be provided. Latency of real-time updates can be decreased by replicating subscription information in each data center, as shown in the example scenario depicted in FIG. 3.

FIG. 3 illustrates an example scenario 300 including a functional block diagram 302 associated with providing real-time updates with replication of subscription information. In FIG. 3, subscription information for User A's subscription to content item A (block 222) has been replicated to each data center. It should be understood that, while in the example scenario, only user A's subscription to content item A is shown in each data center, all subscription information for all users and all content items can be replicated in each data center, such that each data center has subscription information sufficient to identify all users that are subscribed to each content item at a given time. In this scenario, when the content item update for content item A (block 224) is reported to the Asia data center 212, the Asia data center 212 already has a list of all subscribers to content item A. As such, real-time updates can be sent to each subscriber of content item A without having to query any additional data centers, thereby reducing the latency of the real-time updates. When User A closes content item A, subscription information in each data center can be updated to remove User A's subscription to content item A.

Although replication of subscription information to every data center results in the best performance in terms of providing real-time updates with the lowest latency, it can be very inefficient. As noted previously, a social networking system can include millions of users viewing millions of content items simultaneously. Replicating all of the subscription information for all of these users viewing content items requires an enormous amount of data replication. Furthermore, a large percentage of the data generation, replication, and deletion may not be necessary. This is due to the fact that real-time updates are provided only if one user is viewing a content item, and another user is interacting with the content item at the same time. However, if a user opens a content item, views the content item, and then closes the content item, without another user interacting with the content item during that time, subscription information is generated, replicated, and then deleted without the subscription information ever being used. In many instances, a user looks at a content item for only a few seconds, and, during that time, no other users interact with the content item. The replication of subscription information in such scenarios can represent a wasted expenditure of resources.

Returning to FIG. 1, the real-time updates module 102 can be configured to make a replication determination to determine whether or not to replicate subscription information based on replication criteria. For example, if it is determined that it is highly unlikely that a particular content item will have users interacting with the content item simultaneously, subscription information for that content item may not be replicated. Conversely, if it is determined that the likelihood of simultaneous user interactions with a content item is very high, then subscription information for that content item can be replicated. The replication determination and various examples of replication criteria will be described in greater detail herein.

As shown in the example of FIG. 1, the real-time updates module 102 can include a content item subscription module 104, a replication determination module 106, and a content item update module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the real-time updates module 102 can be implemented in any suitable combinations.

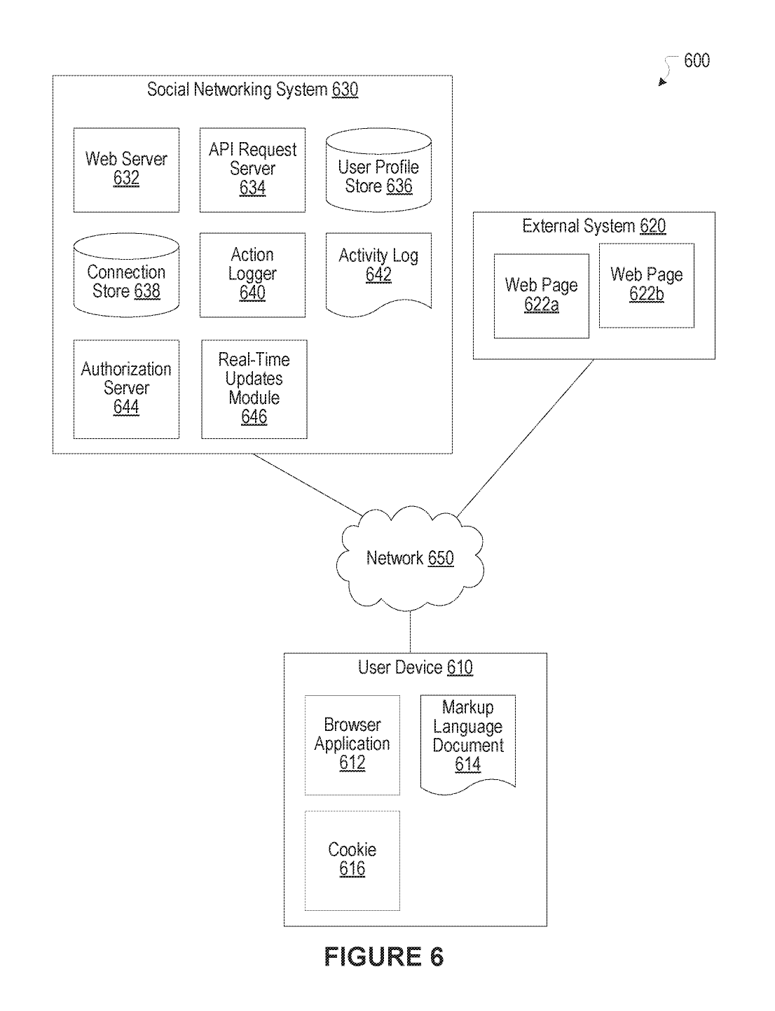

In some embodiments, the real-time updates module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the real-time updates module 102 can be implemented, in part or in whole, as software running on one or more computing devices or systems, such as on a user or client computing device. For example, the real-time updates module 102, or at least a portion thereof, can be implemented as or within an application (e.g., app), a program, or an applet, etc., running on a user computing device or a client computing system, such as the user device 610 of FIG. 6. In another example, the real-time updates module 102, or at least a portion thereof, can be implemented using one or more computing devices or systems that include one or more servers, such as network servers or cloud servers. In some instances, the real-time updates module 102 can, in part or in whole, be implemented within or configured to operate in conjunction with a social networking system (or service), such as the social networking system 630 of FIG. 6. It should be understood that there can be many variations or other possibilities.

The real-time updates module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the real-time updates module 102. For example, the data store 110 can store content item information, user information, subscription information, replication criteria, and the like. It is contemplated that there can be many variations or other possibilities.

The content item subscription module 104 can be configured to manage subscriptions between users and content items. Management of subscriptions can include generation and deletion of subscription information based on users opening and closing content items. In certain embodiments, a subscription can be generated between a user and a content item when the user opens the content item. For example, a subscription can be generated between a user and a content item when the user views and/or is presented with the content item on a social networking system. The subscription can remain active while the content item remains open (e.g., while the user is still viewing the content item), and can be closed when the content item is closed (e.g., when the user stops viewing the content item). While a subscription is open between a user and a content item, the user can be provided with real-time updates for the content item. For example, while the user is viewing the content item, the user can be presented with a real-time tally of the number of users that have liked the content item, a real-time tally of the number of users that have commented on the content item, a real-time indication of one or more users currently entering a comment for the content item, a real-time stream of comments to the content item as they are being posted by other users, and the like. In certain embodiments, subscription information for a user's subscription to a content item can be initially stored in one data center of a plurality of data centers. For example, as discussed above, a social networking system may comprise a plurality of data centers. Each data center can be associated with a particular geographic region. Subscription information for a user's subscription to a content item can be stored in a data center associated with a geographic region associated with the user (e.g., the data center associated with the geographic region in which the user is currently located). Subscription information can then be replicated to additional data centers, as will be discussed in greater detail with reference to the replication determination module 106. If subscription information is replicated to multiple data centers, deletion of subscription information (e.g., when a user closes a content item) can also be replicated across the multiple data centers such that the subscription maintained at each data center remains accurate and updated.

The replication determination module 106 can be configured to make a replication determination for subscription information based on replication criteria. As indicated above, while it may provide the greatest latency benefits, it may be inefficient to replicate all subscription information for all users viewing content items on a social networking system to all data centers of the social networking. As such, in various embodiments, only a subset of subscription information is selected for replication to multiple data centers. For each subscription between a content item and a user, a replication determination is made based on replication criteria as to whether or not to replicate subscription information for that subscription to multiple data centers. The replication criteria can be based on a likelihood that multiple users will simultaneously view and/or interact with a content item, such that the replicated subscription information will actually be useful. For example, replication criteria can include potential audience criteria indicative of the number of users that could potentially view and/or interact with a content item. For example, privacy settings on a content item may restrict the number of users that are able to view and/or interact with a content item. If the number of users that are able to view a content item falls below a potential audience threshold, subscription information for that content item may not be replicated.

Replication criteria can include current audience criteria indicative of the number of users currently subscribed to a content item. If a large number of users are currently viewing a content item, it is likely that there will be some simultaneous interaction with the content item by multiple users. As such, if the number of current users subscribed to a content item exceeds a current user subscription threshold, subscription information for that content item can be replicated.

Replication criteria can also include interaction rate information, such as the rate at which users are currently commenting and/or otherwise interacting with the content item. If a content item has had a high level of interaction over a prolonged period of time, it is likely that such interaction will continue, and, as such, subscription information for that content item can be replicated.

Replication criteria can also include network usage criteria. For example, it may be determined that based on historical network usage data that a social networking system's network resources may be over-utilized during certain times of day, and underutilized during other times of day. During those times when the social networking system is typically underutilized, efficient resource management may not be as much of a concern. As such, subscription information for all content items may be replicated during those times when the social networking system's network resources are typically underutilized.

In certain embodiments, replication determinations may be made on a content item basis, such that the replication determination turns replication on or off for all subscription information for a content item. In other embodiments, replication determinations can be made on a user-by-user, subscription-by-subscription basis. For example, when a user opens a content item, it can be determined whether or not the user is likely to view the content item for a threshold period of time. If the user is likely to view the content item for a sufficient period of time (i.e., satisfies the threshold period of time), subscription information associated with the user and the content item can be replicated.

In certain embodiments, if a replication determination indicates that particular subscription information should be replicated, then the subscription information can be replicated to all data centers in a plurality of data centers. In other embodiments, the replication determination may comprise a determination of a subset of data centers to replicate to. For example, if the potential audience of a content item (e.g., based on privacy settings for the content item) is clustered in a particular geographic region, then subscription information for that content item can be replicated to a data center associated with that geographic region, but not other data centers. In another example, if a content item is written in a particular language, then subscription information for that content item can be replicated to data centers associated with geographic regions that speak or use the particular language, and not replicated to other data centers.

The content item update module 108 can be configured to provide real-time updates for content items to subscribers. When a user interacts with a content item, the content item update module 106 can receive an indication of an update to the content item. One or more data centers can be queried to identify subscribers to the content item. The update can be provided to the subscribers of the content item.

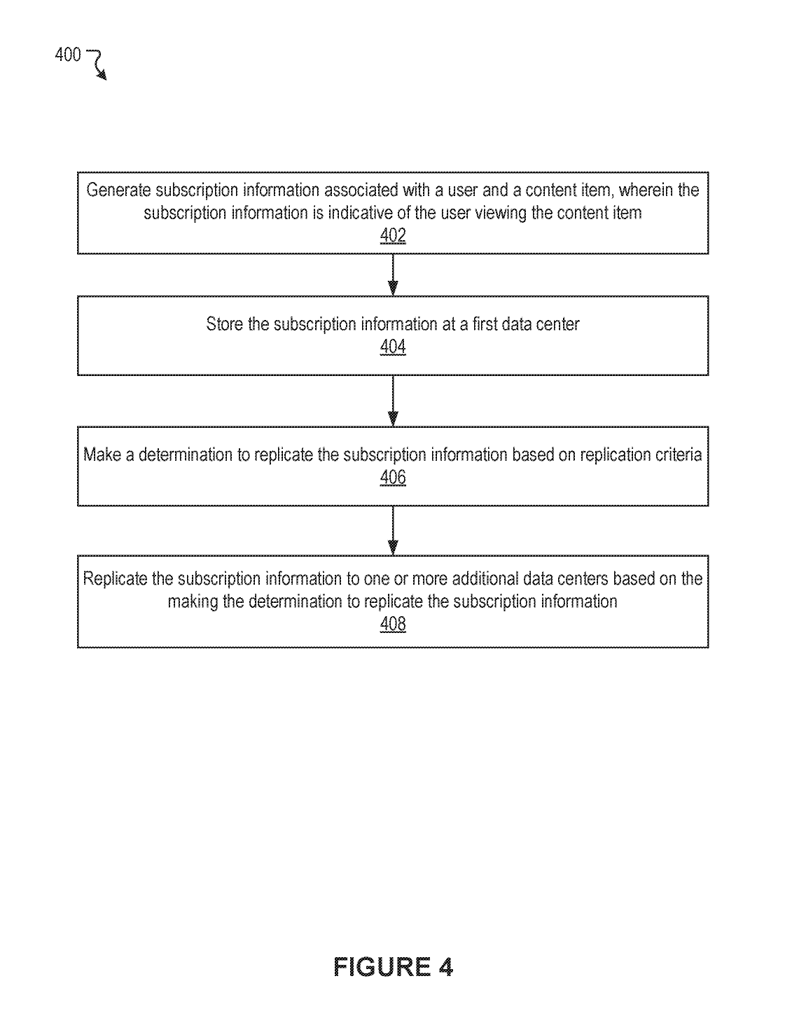

FIG. 4 illustrates an example method 400 associated with replicating subscription information based on a replication determination, according to an embodiment of the present disclosure. It should be appreciated that there can be additional, fewer, or alternative steps performed in similar or alternative orders, or in parallel, within the scope of the various embodiments discussed herein unless otherwise stated.

At block 402, the example method 400 can generate subscription information associated with a user and a content item, wherein the subscription information is indicative of the user viewing the content item. At block 404, the example method 400 can store the subscription information at a first data center. At block 406, the example method 400 can make a determination to replicate the subscription information based on replication criteria. At block 408, the example method 400 can replicate the subscription information to one or more additional data centers based on the making the determination.

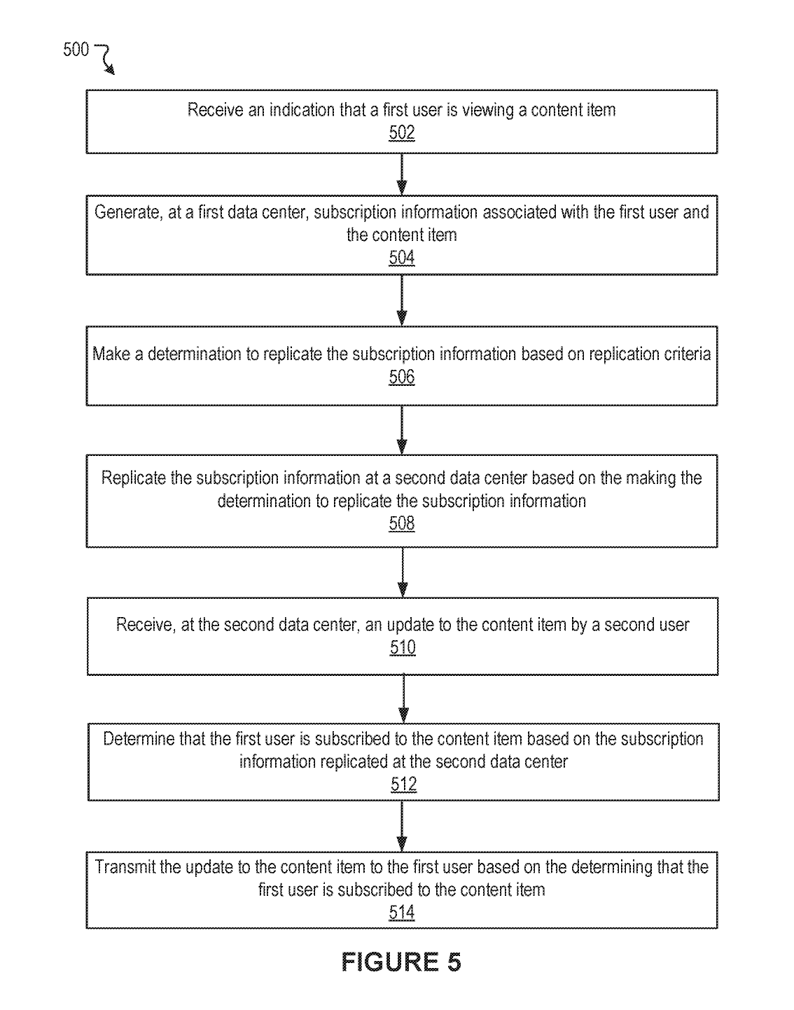

FIG. 5 illustrates an example method 500 associated with providing real-time updates for a content item, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive an indication that a first user is viewing a content item. At block 504, the example method 500 can generate, at a first data center, subscription information associated with the first user and the content item. At block 506, the example method 500 can make a determination to replicate the subscription information based on replication criteria. At block 508, the example method 500 can replicate the subscription information at a second data center based on the making the determination to replicate the subscription information. At block 510, the example method 500 can receive, at the second data center, an update to the content item by a second user. At block 512, the example method 500 can determine that the first user is subscribed to the content item based on the subscription information replicated at the second data center. At block 514, the example method 500 can transmit the update to the content item to the first user based on the determining that the first user is subscribed to the content item.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a real-time updates module 646. The real-time updates module 646 can, for example, be implemented as the real-time updates module 102, as discussed in more detail herein. As discussed previously, it should be appreciated that there can be many variations or other possibilities. For example, in some embodiments, one or more functionalities of the real-time updates module 646 can be implemented in the user device 610.

### Hardware Implementation

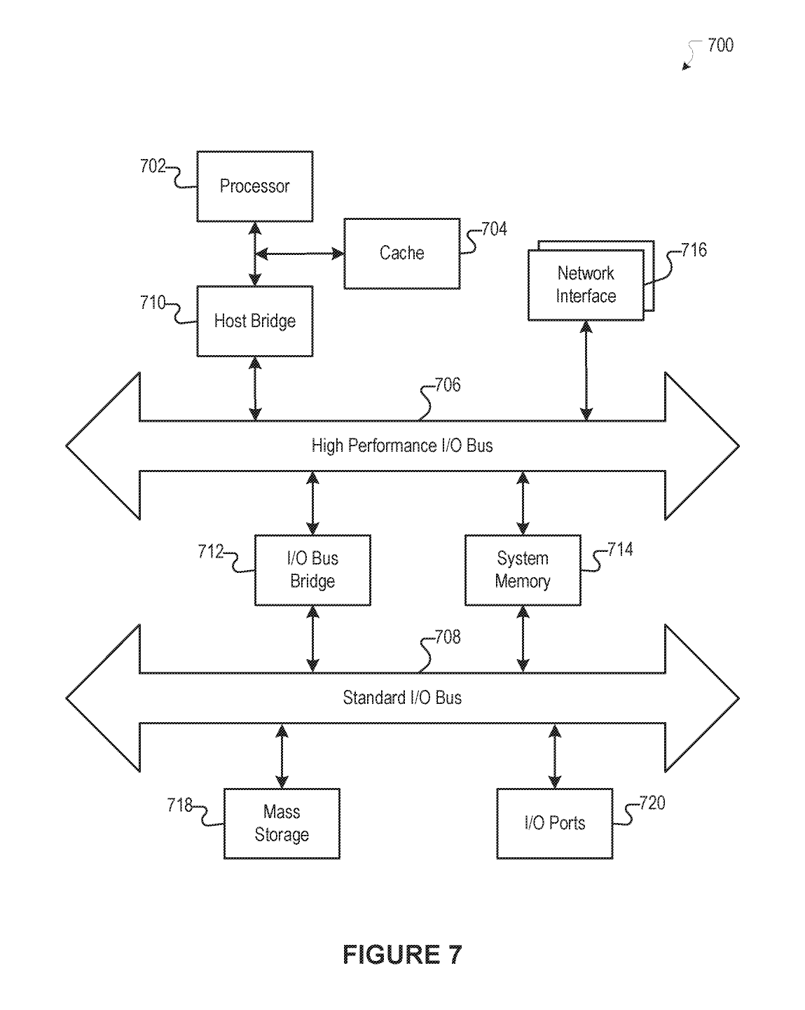

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
generating, by a computing system, subscription information associated with a user and a content item, wherein the subscription information is indicative of the user viewing the content item;
storing, by the computing system, the subscription information at a first data center;
making, by the computing system, a determination to replicate the subscription information based on replication criteria; and
replicating, by the computing system, the subscription information to one or more additional data centers based on the making the determination to replicate the subscription information.

2. The computer-implemented method of claim 1, wherein the replication criteria comprise potential audience criteria.

3. The computer-implemented method of claim 1, wherein the replication criteria comprise current audience criteria.

4. The computer-implemented method of claim 1, wherein the replication criteria comprise network usage criteria.

5. The computer-implemented method of claim 4, wherein the network usage criteria comprise a low usage period identified based on historical network usage data.

6. The computer-implemented method of claim 1, wherein the making the determination to replicate the subscription information comprises making a determination to replicate all subscription information associated with the content item.

7. The computer-implemented method of claim 1, wherein the replicating the subscription information to one or more additional data centers comprises replicating the subscription information to all data centers of a social networking system.

8. The computer-implemented method of claim 1, wherein the making the determination to replicate the subscription information comprises determining a subset of data centers of a plurality of available data centers to which the subscription information will be replicated.

9. The computer-implemented method of claim 1, wherein the first data center is associated with a geographic region in which the user is located.

10. The computer-implemented method of claim 1, further comprising:
determining that the user is no longer viewing the content item; and
removing the subscription information from the first data center and the one or more additional data centers.

11. A system comprising:
at least one processor; and
a memory storing instructions that, when executed by the at least one processor, cause the system to perform a method comprising:
generating subscription information associated with a user and a content item, wherein the subscription information is indicative of the user viewing the content item;
storing the subscription information at a first data center;
making a determination to replicate the subscription information based on replication criteria; and
replicating the subscription information to one or more additional data centers based on the making the determination to replicate the subscription information.

12. The system of claim 11, wherein the replication criteria comprise potential audience criteria.

13. The system of claim 11, wherein the replication criteria comprise current audience criteria.

14. The system of claim 11, wherein the replication criteria comprise network usage criteria.

15. The system of claim 14, wherein the network usage criteria comprise a low usage period identified based on historical network usage data.

16. A non-transitory computer-readable storage medium including instructions that, when executed by at least one processor of a computing system, cause the computing system to perform a method comprising:
generating subscription information associated with a user and a content item, wherein the subscription information is indicative of the user viewing the content item;
storing the subscription information at a first data center;
making a determination to replicate the subscription information based on replication criteria; and
replicating the subscription information to one or more additional data centers based on the making the determination to replicate the subscription information.

17. The non-transitory computer-readable storage medium of claim 16, wherein the replication criteria comprise potential audience criteria.

18. The non-transitory computer-readable storage medium of claim 16, wherein the replication criteria comprise current audience criteria.

19. The non-transitory computer-readable storage medium of claim 16, wherein the replication criteria comprise network usage criteria.

20. The non-transitory computer-readable storage medium of claim 19, wherein the network usage criteria comprise a low usage period identified based on historical network usage data.
